(19) United States
(12) Patent Application Publication
(10) Pub. No.: US 2026/0100840 A1
(43) Pub. Date: Apr. 9, 2026

(54) Method and System for Log In

(71) Applicant: Cyphercor Inc., Kanata (CA)

(72) Inventor: Diego Matute, Kanata (CA)

(21) Appl. No.: 19/328,181

(22) Filed: Sep. 14, 2025

Related U.S. Application Data
(60) Provisional application No. 63/703,972, filed on Oct. 6, 2024.

(51) Int. Cl. H04L 9/32

(52) U.S. Cl. CPC H04L 9/3226; H04L 9/3268; H04L 9/3271

(57) ABSTRACT

Disclosed is a method for authenticating a user to a resource. An authentication request is received at a first system from a first remote system. The first system communicates with a first remote portable hardware device coupled with the first remote system. A cryptographic authentication is performed between the first remote portable hardware device and the first system to determine an authentication result. The authentication result is then transmitted to the first remote system in response to the authentication request.

### FIELD OF THE INVENTION

The invention relates generally to computer security and more particularly to computer security relying on a hardware device for authentication, the computer security supporting logging into sites via the World Wide Web and into systems via software that is not World Wide Web compliant.

### BACKGROUND

Computer security is a complex field that relies on knowledge, identity, and possessions—e.g. passwords, biometrics, and access cards/devices—to securely authenticate individuals. It is well known in the security community that there is a common trade-off between convenience and security. A password, such as a child's name, is easy to remember but relatively insecure. A password with 64 random letters is much more secure, but quite difficult to remember. In person authentication can be quite secure, but it is also very inconvenient for online shopping. The holy grail of computer security is a system or method that is both convenient and secure.

There are several common approaches to violating security of Internet accounts. In a first approach, a service provider system is infiltrated providing access to services and accounts; for example, an online merchant's systems are hacked. Because of the value of the merchant's data such infiltration is often difficult, requiring a flaw in the security of the service provider. In another approach, a user's password is compromised by guessing same or by a brute force attack for determining same. In any event, the password, once known, gives a hacker access to the account as if the attacker were the account owner. Both of these approaches requires some skill in computer security.

In a third approach, a user is fooled into providing their credential. For example, a site with a similar but different URL is set up that looks like the original site. When the user tries to log in, they provide their real credentials to the fake “spoof” system, thereby compromising their own security. Spoofing and Phishing have grown in complexity and effectiveness over the past decade.

To limit spoofing, systems often store passwords locally and allow users to select passwords for the specific URL they are accessing. Thus, if your password is not retrieved for the Web page you are looking at, then the URL is unrecognised by the password manager, etc. However, such a system has other drawbacks, for example it is typically limited to a single user of a single system. Storing of password data accessible from within a general-purpose computer is not advisable as this also provides an attack vector for compromising all user accounts.

To solve these problems, companies have built external USB devices that recognise URLs and provide passwords for those URLs—an external version of the password manager. Unfortunately, to make the devices backward compatible and convenient, the passwords are typically backed up in the cloud and these cloud password stores have been compromised. Other attack vectors are also known for USB password managers.

Therefore, there is a search for a better way to authenticate to computer systems that is secure, convenient, and effective.

### SUMMARY OF EMBODIMENTS

In accordance with an embodiment there is provided a method comprising: receiving at a first system from a first remote system an authentication request via a network; communicating by the first system via the network with a first remote portable hardware device communicatively coupled with the first remote system; performing a cryptographic authentication between the first remote portable hardware device and the first system to determine an authentication result; and transmitting the authentication result to the first remote system in response to the authentication request.

In some embodiments the method comprises: receiving at a first system from a second remote system an authentication request; communicating by the first system with the first remote portable hardware device coupled with the second remote system; performing a cryptographic authentication between the first remote portable hardware device and the first system to determine an authentication result; and transmitting the authentication result to the second remote system in response to the authentication request.

In some embodiments the method comprises: receiving at a first system from a second remote system an authentication request; communicating by the first system with a second remote portable hardware device coupled with the second remote system; performing a cryptographic authentication between the second remote portable hardware device and the first system to determine an authentication result; and transmitting the authentication result to the second remote system in response to the authentication request.

In some embodiments the method comprises: receiving at a first system from the second remote system an authentication request; communicating by the first system with the first remote portable hardware device coupled with the second remote system; performing a cryptographic authentication between the first remote portable hardware device and the first system to determine an authentication result; and transmitting the authentication result to the second remote system in response to the authentication request.

In some embodiments cryptographic authentication is certificate based.

In some embodiments cryptographic authentication is challenge-response based.

In some embodiments cryptographic authentication is in accordance with the FIDO2 authentication standard.

In some embodiments the first remote portable hardware device comprises a USB key.

In some embodiments the first remote portable hardware device comprises a smart phone.

In some embodiments the smart phone is communicatively connected with the first remote system wirelessly.

In some embodiments the authentication request is provided by the first system as a second factor in a two-factor authentication process.

In accordance with an embodiment, there is provided a method comprising: initiating on a first system a two-factor authentication request; providing user authentication information to the first system; providing a request from the first system via a wide area network to a second other system for a second factor authentication, the second factor authentication relying on cryptographic authentication of a remote portable hardware device, the second factor authentication performed absent further user authentication data input for authenticating the user to the first system or to the second other system to complete the user authentication process; performing the second factor authentication; and when the user authentication information and the second factor authentication are each indicative of the user being authenticated, authenticating the user based on a combination of the user authentication information and the cryptographic authentication.

In some embodiments the cryptographic authentication is in accordance with a cryptographic authentication process of one of FIDO and FIDO2 modified to exclude a compliant web browser.

In some embodiments at least part of the two-factor authentication request is performed using a RADIUS protocol to communicate with a RADIUS authentication server, the RADIUS server for facilitating the cryptographic authentication.

In some embodiments the RADIUS authentication server at least one of supports and requests user authentication via a FIDO2 protocol modified to exclude a compliant web browser.

In some embodiments the RADIUS authentication server at least one of supports user authentication via a cryptographic challenge-response exchange and interacts with another process providing user authentication via a cryptographic challenge-response exchange.

In some embodiments user authentication information comprises a user ID and a password.

In some embodiments cryptographic authentication comprises: communicating with the remote portable hardware device based on the user authentication information; performing a cryptographic challenge for verifying the hardware device; when the hardware device is other than verified, other than authenticating the user; and when the hardware device is verified, authenticating the user.

In accordance with an embodiment there is provided a method comprising: providing support for a RADIUS authentication protocol request within first software in execution on a first system; communicating by the first software with an external device in execution of the RADIUS protocol for cooperatively performing authentication of a user, an authentication request; communicating by the external device to a cryptographic authentication process to verify a user of the first software with a cryptographic challenge; and based on a result of the cryptographic challenge, authenticating the user and providing the authentication data from the external device in accordance with the RADIUS protocol to the first software in response to the authentication request.

In accordance with an embodiment, there is provided a method comprising: installing an agent onto a computer system, the agent for supporting user authentication of a user to software in execution on the system other than software that the agent forms part of, the authentication performed in association with an external hardware device.

In some embodiments the authentication is in accordance with the FIDO2 protocol modified to exclude a compliant web browser.

In some embodiments the authentication the user is performed in dependence upon a cryptographic exchange of data.

In accordance with an embodiment, there is provided a method comprising: trapping an authentication request by an agent in execution in the background of a computer system; communicating with an external device for cooperatively performing authentication of a user; and based on the communication, authenticating the user and providing the authentication data in response to the authentication request.

In some embodiments authenticating the user is performed in dependence upon a cryptographic exchange of data.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 illustrates a simplified methodology of a traditional business process audit according to prior art.

FIG. 2 is a simplified flow diagram of a method of using FIDO2 with software that does not support FIDO2.

FIG. 3 is a simplified block diagram of a hardware key entry system used for legacy system access.

FIG. 4 is a simplified flow diagram of another embodiment wherein a two-factor authentication process is employed.

FIG. 5 is a simplified flow diagram of another embodiment where in the second factor authentication server relies on Remote Authentication Dial-In User Service (RADIUS).

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

Fast Identity Online (FIDO) is an open standard predecessor to the FIDO2 open standard.

Fast Identity Online 2 (FIDO2) is an open standard released in 2018 for user authentication that aims to strengthen the way people sign in for online data access, online data communication, and online services

Passwordless is a user authentication process that operates without a password. Examples of passwordless systems include in person authentication, biometric authentication, certificate-based authentication and device-based authentication such as that of FIDO2.

Cryptographic refers to any process relying on cryptography.

Key as used herein refers to digital data used in at least one of securing, unsecuring, and signing of plain text data.

Keypair two keys form a key pair for private/public key cryptography.

Private key a key that is kept secret. Disclosure of the private key renders the cryptographic process relatively pointless.

Public key a portion of a key pair that can be made completely public. The public key allows one to cryptographically process data and have that cryptographic process reversed by a holder of the private key.

Wireless refers to any communication between two devices that is not performed due to a contact therebetween, but instead is performed via electromagnetic signals propagating therebetween and not via a conductive path.

NFC refers to near field communication and generally refers to a set of standards for wireless communication.

Universal Serial Bus (USB) is an industry standard that allows data exchange and delivery of power between many types of electronics.

USB Key is a USB data storage device for use in user identification or authentication.

Biometric refers to processes that rely on biological information for performing user identification or authentication. Examples of biometric authentication include fingerprint, retinal scan, facial recognition and voice recognition.

Biometric lock refers to a lock that is operable based on biometric information.

FIDO2 has a stated goal of increasing overall trust by improving overall security and protecting individuals and organizations from cybercrimes. In essence, FIDO2 aims to replace legacy passwords and increase trust through phishing-resistant cryptographic credentials for validating user identities.

FIDO2 solution blocks are implemented within web browsers, for example for Windows, Linux, Mac, Android, etc. Thus, using a system and browser that supports FIDO2, one can rely on FIDO2 for user authentication for their online activities. The effort to design a more secure access method is applied to very specific software—web browsers. Other software is only capable of supporting FIDO2 when the software developer modifies the software to support different authentication techniques. Thus, each software application needs modification to support any new authentication technique.

Passkeys are FIDO2 sign-in credentials that are created using public key cryptography. Passkeys increase security and increase convenience when and where they are supported and used. FIDO2 passwordless authentication relies on cryptographic processes to generate a pair of private and public passkeys—long, random numbers that are mathematically related. The key pair is stored without the user needing to remember the contents of each key. The keypair is then used to perform user authentication directly with a server that supports FIDO2.

Effectively, FIDO2 relies on cryptographic data exchange to limit effective communication to between two endpoints, relying on a challenge response structure. This eliminates the potential to intercept a password and then to reuse that password over and over again. The public key for a key pair is encrypted and, along with a randomly generated credential ID, registered with the service and stored on its authenticator server.

There are two types of FIDO authenticators: Roaming or cross-platform authenticators are portable hardware devices that are separate from users'client devices. Roaming authenticators include security keys, smartphones, tablets, wearables, and other devices that connect with client devices through the USB protocol or near-field communication (NFC) and Bluetooth wireless technology. Users verify their identities in a variety of ways, such as by plugging in a FIDO key and pressing a button or by providing a biometric, such as a fingerprint. Roaming authenticators are also known as cross-platform authenticators because they allow users to authenticate on multiple computers, anytime, anywhere. Platform or bound authenticators are embedded in users'client devices, whether a desktop, laptop, tablet, or smartphone.

To sign-in to a service using FIDO2, the service issues a cryptographic challenge to confirm your presence. When prompted, a user performs a same authenticator gesture used during account registration—for example providing their fingerprint. Once you have confirmed your presence, the device uses the private key stored locally on the user's device to sign the challenge. The device then sends the signed challenge back to the service, which verifies it with the securely registered public key. Thus, FIDO2 has several parts, user authentication to the FIDO compliant device (CTAP2) and service authentication to log the user in (WebAuthn).

Implementing the FIDO2 standard on websites and apps requires an organization to have modern hardware and software. Fortunately, all leading web platforms, including Microsoft Windows, Apple iOS and MacOS, and Android systems, and all major web browsers, including Microsoft Edge, Google Chrome, Apple Safari, and Mozilla Firefox, support FIDO2. Your identity and access management (IAM) solution must also support FIDO2 authentication.

In general, implementing FIDO2 authentication in new or existing websites and apps entails these key steps: Define the user login experience and authentication methods, and set access control policies. Create new or modify existing registration and sign-in pages with the appropriate FIDO protocol specifications. Set up a FIDO server to authenticate FIDO registration and authentication requests. Build new or modify existing authentication workflows. This process has been streamlined and made easy to implement for most web-based services.

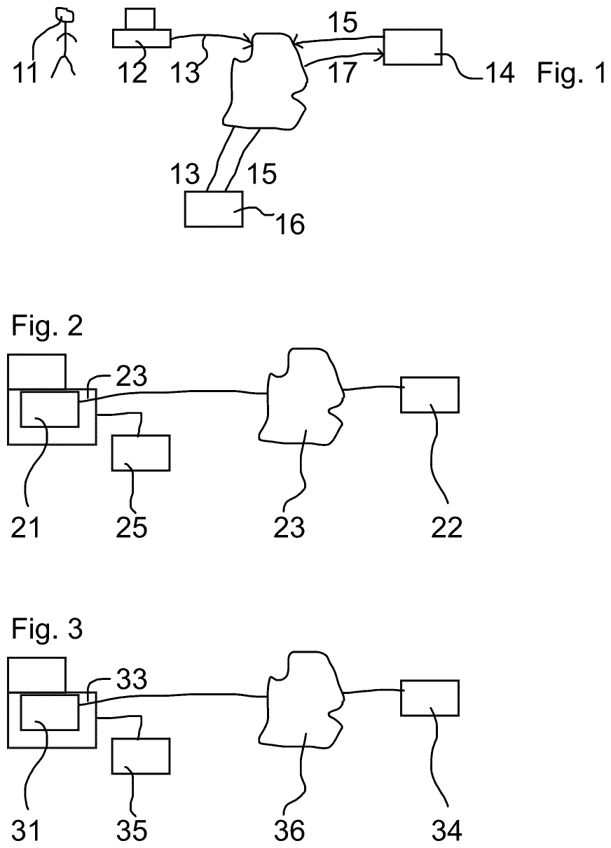

Referring to FIG. 1, shown is a simplified block diagram of a FIDO2 authentication exchange. A user 11 enters a URL at their computer 12. The URL addresses communication with a server 14. The user 11 provides knowledge in the form of a password 13 via the computer 12 to a FIDO2 device 16. The server 14 provides a challenge 15 to the FIDO2 device 16. The FIDO2 device 16 based on verifying the password 13 responds to the challenge 15 with a signed assertion 17. Thus, access to server 14 is only enabled when the server URL and the password 13 are recognised/authenticated by the FIDO2 device 16. The signed assertion 17 provides verification to the server 14 that the FIDO2 device 16 is present and has authenticated the user 11. The FIDO2 authentication is usable when FIDO2 compliant software is accessed or is used to access a URL and when the user has already set up a keypair for the URL.

It would be more useful and convenient if FIDO2 was useful with legacy software. For example, what if FIDO2 could be used to access software that does not support FIDO2 authentication.

Referring to FIG. 2, shown is a simplified method of using FIDO2 with software that does not support FIDO2. Here, an agent 21 is installed on the computer system 23. The agent is FIDO2 compliant. A compatible FIDO2 server 22 is installed for being accessed by the agent 21 via the world wide web 23. When the computer system 23 asks for a password and the password entry screen is recognised/supported by the agent 21, the agent 21 takes over operation. A passwordless FIDO2 device 25 is contacted for performing a challenge response. The agent 21 supports the passwordless FIDO2 challenge response process. The agent 21 then provides a password to the password entry screen. The agent acts to allow FIDO2 to be used with legacy password entry and user authentication infrastructure, converting a FIDO2 system that is of limited usefulness into a potentially ubiquitous system.

In an embodiment, the process of recognising the password entry screen optionally verifies other aspects of the computer system 23 such as memory contents, in order to prevent spoofing.

In an embodiment, the passwords are stored by the agent 21. In another embodiment, the password is stored by the passwordless FIDO2 device 25. In yet another embodiment, the passwordless FIDO2 device 25 cryptographically decodes the password it receives from the agent 21 and returns the password for being accessed by the agent 21 and provided to the password entry screen.

Here, an agent supports FIDO2 and supports key pairs with a passwordless hardware device. The keypairs are contextual and, as such, the system retains all or nearly all the benefits of FIDO2, but instead of only supporting the solution for online websites and applications, the agent allows its extension to other applications. Further, when passwords are stored cryptographically secured on the FIDO2 device, the portability of the device and security thereof are mapped onto password-based systems, though compromise of the passwords remains a concern, that is difficult to avoid for all password-based systems.

In a simple embodiment, the agent 21 mimics keyboard and/or mouse functionality allowing it to select input fields and enter keyboard data to the input fields. Thus, the agent, once provided a password or once authorised to retrieve a password can enter the password in a legacy fashion into a password entry field.

Referring to FIG. 3, shown is a simplified block diagram of a hardware key entry system used for legacy system access. Here, an agent 31 installed within the legacy system 33 is in execution in the background. The agent 31, when an authentication request is detected, determines a type of authentication request, a requestor, etc. For example, a type of authentication request includes a protocol for entering authentication information.

Once the requestor 34—the system, software, service, or document requiring authentication—is known, the agent 31 knows how to identify authentication information. For example, it retrieves authentication data previously stored or it provides an indicator to an external cryptographic device relating to which password is being requested. For a cloud-based service accessed via the world wide web 36, the requestor 34 is the URL; this prevents spoofing. For other applications, it is an identifier.

When the password is stored locally, the agent 31 then engages in a user authentication process with the hardware key 35 in order to authorise password extraction and provision. When the password is stored on the hardware key, the agent 31 requests the password from the hardware key 35 as part of the user authentication process. In any event, the password is provided automatically when the user is authenticated.

When the hardware key 35 is FIDO2 compliant, to the end-user the process appears identical to FIDO2 authentication via a web browser. Instead of a website requesting a password, the agent 31 engages and the FIDO2 authentication is initiated. The user engages with the hardware key 35 as if the system 33 were requesting a passwordless authentication and, when authenticated, the system 33 is provided the password without the user remembering the password or typing the password. In this example, the FIDO2 security hardware is sued as a single sign on method for the user for FIDO2 compliant browsers and when FIDO2 is unsupported by the software in execution.

Further advantageously, different hardware keys are usable for different purposes. A single user could have a personal hardware key, a work hardware key, and a management hardware key such that accessing specific documents or files requires the associated hardware key, but nothing more, even though they are mostly accessed via an identical agent on a same computer system.

When different hardware keys are used, the accounts and authentications themselves may differ. For example, one key provides access to work accounts, work servers, and work services. Another key provides access to personal banking, personal email, and personal accounts and services.

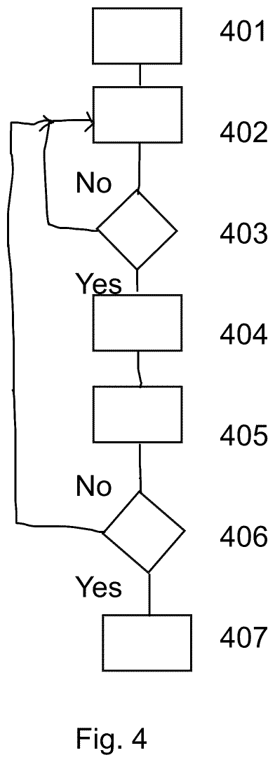

Referring to FIG. 4, shown is a simplified flow diagram of an embodiment wherein a two-factor authentication process is employed. Types of two-factor authentication are known and are relatively straightforward to integrate into an existing login process. Once the login process is initiated at 401, the user ID and password is provided at 402 for verification at 403 in accordance with a legacy process. When verified, the system contacts an external server at 404 for second factor authentication. The server is set up to provide further security for authentication. For example, the server knows another channel of communication with a user to verify the second channel. In the present embodiment, the server relies on FIDO2 compliant authentication. The server requests at 405, in accordance with the FIDO2 standard a cryptographic exchange to verify at 406 that a FIDO2 compliant USB device is in communication with the user's computer. When the FIDO2 compliant device responds correctly, the server provides an authentication code at 407 for second factor authentication. Examples of authentication codes include one-time passwords provided to the user for entry as second factor authentication, verification codes provided from the server directly to the software to provide access, and other access codes.

Thus, the user is authenticated and their FIDO2 compliant device is also authenticated. If a user logs in without the FIDO2 compliant device, the second factor fails. If they login with their FIDO2 compliant device and authorise the cryptographic exchange by authenticating to the FIDO2 compliant device, then the server one of provides the user with a code for indicating FIDO2 compliant authentication is successful or communicates with the legacy software to indicate that the second factor authentication is successful.

When a code is used, this allows a user to rely upon a USB device instead of relying on their phone number and a text message. When the server communicates directly with the legacy software, the second factor is seamless and the login proceeds without further user action.

In an extreme case, the user could set up the software with a simple password such as “11” or their name and rely exclusively on the FIDO2 security.

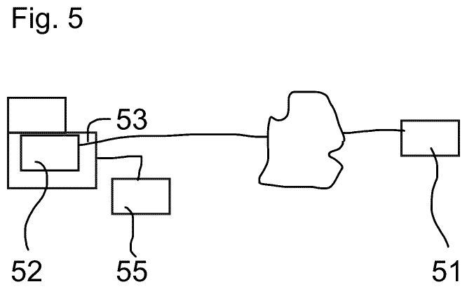

Referring to FIG. 5, shown is another embodiment where in the second factor authentication server relies on Remote Authentication Dial-In User Service (RADIUS). Remote Authentication Dial-In User Service (RADIUS) is a networking protocol that provides centralized authentication, authorization, and accounting (AAA) management for users who connect and use a network service or software relying on the RADIUS protocol. RADIUS was developed by Livingston Enterprises in 1991 as an access server authentication and accounting protocol. It was later brought into IEEE 802 and IETF standards.

RADIUS is a client/server protocol that runs in the application layer and can use either TCP or UDP. Presently, network access servers, which control access to a network, usually contain a RADIUS client component that communicates with the RADIUS server. RADIUS is often the back-end of choice for 802.1X authentication. Thus, RADIUS is already deployed in a wide range of locations. Adding RADIUS clients to legacy software is in most situations not complicated.

A RADIUS server 51 is usually a background process running on UNIX or Microsoft Windows. The RADIUS server 51 can be executed in the cloud or on a specific hardware device.

In accordance with the RADIUS process, a user or user system 53 sends a RADIUS Access Request message to a RADIUS server 51 requesting authorization to grant access via the RADIUS protocol and including user related information. In the present embodiment, the access credentials are used to initiate a cryptographic challenge-response with a FIDO2 key 55 in accordance with the FIDO2 protocol.

The request includes access credentials, typically in the form of user identification. Additionally, the request may contain other information which the NAS knows about the user, such as its network address and/or phone number.

The RADIUS server 51 verifies that the information is correct by calling an external authentication process using FIDO2 authentication protocol. Relying on a cryptographic challenge response, the external authentication server authenticates the user and transmits results to the RADIUS server 51 for communicating a response to the request, for example authenticating the user. Historically, RADIUS servers checked the user's information against a locally stored flat file database. In the present embodiment, the RADIUS server 51 relies on a FIDO2 compliant process for authentication. Alternatively, the FIDO2 compliant user authentication process is integrated into the RADIUS server processes.

The RADIUS server 51 then returns a response in accordance with the RADIUS protocol to the software 52; these include Access Reject and Access Accept.

When Access Reject is returned, the user is unconditionally denied access to all requested resources. Reasons may include failure to provide proof of identification or an unknown or inactive user account.

When Access Accept is returned, the user is granted access—signed in.

Optionally, legacy software employs the RADIUS protocol at intervals, for example after a period of non-use, in order to authorise the user to remain logged in. In such a case, the RADIUS server 51 optionally requires a full user authentication to the FIDO2 device or, alternatively, only verifies that the FIDO2 device remains installed on the user's system.

Of course, other protocols different from RADIUS modified to execute a FIDO2 protocol are also contemplated. Other user authentication protocols other than the FIDO2 protocol are also contemplated such as the FIDO protocol, a certificate-based protocol, a FIPS compliant protocol, etc.

In yet another embodiment, all access requests are via the World Wide Web. Here, instead of routing an application's authentication process via a FIDO2 compliant browser, the agent automatically inserts itself as the intermediary in a web compliant FIDO2 authentication process. A user launches an application local to their computer system. The application, on start-up, displays a user authentication screen. The application screen is verified as is the application. The agent then communicates via the World Wide Web to perform FIDO2 level authentication, for example with the key provider server. Once authenticated, keys are at least one of retrieved and reassembled based on data from the server and data from the USB key to provide authentication data in the form of a password to the authentication screen.

Thus, following FIDO2 protocols and using a FIDO2 USB key, a user logs into local software on their device securely and conveniently. For the FIDO2 process to have the correct authentication data, the authentication process is set up or reset with the assistance of the FIDO2 USB key. By using the FIDO2 USB key in resetting authentication data, the resulting password, for example, is unknown to the user and is retrievable using the FIDO2 process and the FIDO2 USB key.

Numerous other embodiments are envisaged without departing form the spirit and scope of the invention.

What is claimed is:

1. A method comprising:
receiving at a first system from a first remote system an authentication request via a network;
communicating by the first system via the network with a first remote portable hardware device communicatively coupled with the first remote system;
performing a cryptographic authentication between the first remote portable hardware device and the first system to determine an authentication result; and
transmitting the authentication result to the first remote system in response to the authentication request.

2. A method according to claim 1 comprising:
receiving at a first system from a second remote system an authentication request;
communicating by the first system with the first remote portable hardware device coupled with the second remote system;
performing a cryptographic authentication between the first remote portable hardware device and the first system to determine an authentication result; and
transmitting the authentication result to the second remote system in response to the authentication request.

3. A method according to claim 1 comprising:
receiving at a first system from a second remote system an authentication request;
communicating by the first system with a second remote portable hardware device coupled with the second remote system;
performing a cryptographic authentication between the second remote portable hardware device and the first system to determine an authentication result; and
transmitting the authentication result to the second remote system in response to the authentication request.

4. A method according to claim 3 comprising:
receiving at a first system from the second remote system an authentication request;
communicating by the first system with the first remote portable hardware device coupled with the second remote system;
performing a cryptographic authentication between the first remote portable hardware device and the first system to determine an authentication result; and
transmitting the authentication result to the second remote system in response to the authentication request.

5. A method according to claim 1 wherein cryptographic authentication is certificate based.

6. A method according to claim 2 wherein cryptographic authentication is certificate based.

7. A method according to claim 1 wherein cryptographic authentication is challenge-response based.

8. A method according to claim 2 wherein cryptographic authentication is challenge-response based.

9. A method according to claim 1 wherein cryptographic authentication is in accordance with the FIDO2 authentication standard.

10. A method according to claim 1 wherein the first remote portable hardware device comprises a USB key.

11. A method according to claim 1 wherein the first remote portable hardware device comprises a smart phone.

12. A method according to claim 11 wherein the smart phone is communicatively connected with the first remote system wirelessly.

13. A method according to claim 1 wherein the authentication request is provided by the first system as a second factor in a two-factor authentication process.

14. A method comprising:
initiating on a first system a two-factor authentication request;
providing user authentication information to the first system;
providing a request from the first system via a wide area network to a second other system for a second factor authentication, the second factor authentication relying on cryptographic authentication of a remote portable hardware device, the second factor authentication performed absent further user authentication data input for authenticating the user to the first system or to the second other system to complete the user authentication process;
performing the second factor authentication; and
when the user authentication information and the second factor authentication are each indicative of the user being authenticated, authenticating the user based on a combination of the user authentication information and the cryptographic authentication.

15. A method according to claim 14 wherein the cryptographic authentication is in accordance with a cryptographic authentication process of one of FIDO and FIDO2 modified to exclude a compliant web browser.

16. A method according to claim 14 wherein at least part of the two-factor authentication request is performed using a RADIUS protocol to communicate with a RADIUS authentication server, the RADIUS server for facilitating the cryptographic authentication.

17. A method according to claim 16 wherein the RADIUS authentication server at least one of supports and requests user authentication via a FIDO2 protocol modified to exclude a compliant web browser.

18. A method according to claim 16 wherein the RADIUS authentication server at least one of supports user authentication via a cryptographic challenge-response exchange and interacts with another process providing user authentication via a cryptographic challenge-response exchange.

19. A method according to claim 14 wherein user authentication information comprises a user ID and a password.

20. A method according to claim 14 wherein cryptographic authentication comprises: communicating with the remote portable hardware device based on the user authentication information;
performing a cryptographic challenge for verifying the hardware device;
when the hardware device is other than verified, other than authenticating the user; and
when the hardware device is verified, authenticating the user.
